(19) United States
(12) Patent Application Publication
(10) Pub. No.: US 2026/0138876 A1
(43) Pub. Date: May 21, 2026

(54) SILICA PARTICLES AND METHOD FOR PRODUCING SILICA PARTICLES

(71) Applicant: FUSO CHEMICAL CO., LTD., Osaka-shi, Osaka (JP)

(72) Inventors: Satomi KATO, Osaka-shi, Osaka (JP); Yoshihiro HIRANO, Osaka-shi, Osaka (JP); Masaya KIMURA, Osaka-shi, Osaka (JP); Munenori KOMOTO, Osaka-shi, Osaka (JP); Yasuhiro FUMA, Osaka-shi, Osaka (JP); Kazumi MIKI, Osaka-shi, Osaka (JP)

(73) Assignee: FUSO CHEMICAL CO., LTD., Osaka-shi, Osaka (JP)

(21) Appl. No.: 19/122,419

(22) PCT Filed: Oct. 19, 2023
(86) PCT No.: PCT/JP2023/037831

§ 371 Date: Apr. 18, 2025

(30) Foreign Application Priority Data
Oct. 21, 2022 (JP) 2022-169313

(51) Int. Cl. C01B 33/18

(52) U.S. Cl. CPC C01B 33/18; C01P 2004/61; C01P 2004/62

(57) ABSTRACT

The present invention relates to a method of producing silica particles without using citric acid and also provides silica particles having excellent true density and excellent dispersibility. Provided are silica particles having (1) a true density of 0.8 g/cm³ to 1.4 g/cm³, (2) a particle size distribution in which a frequency of particles larger than twice an average particle size is 15% or less, and (3) a water absorption of 1.0 mass % or less.

### TECHNICAL FIELD

The present invention relates to silica particles and a method of producing silica particles.

### BACKGROUND ART

Patent Literature 1 discloses a technique disclosed by the present applicant. Patent Literature 1 discloses hollow nano-silica particles, wherein (1) an average particle diameter thereof is 50 to 150 nm; (2) average thickness in a shell thereof is 5 to 25 nm; (3) a ratio (I_{Q2}/I_{Q4}), measured through solid NMR (²⁹Si/MAS), of integrated intensity (I_{Q2}) in a peak (Q2) attributed to Si having a cross-linked oxygen number of 2 to integrated intensity (I_{Q4}) in a peak (Q4) attributed to Si having the cross-linked oxygen number of 4 is 0.20 or less; and (4) in a particle size distribution in a range of a particle diameter of 50 to 500 nm, measured by using a disk centrifugal-type particle size distribution-measuring apparatus, a ratio Psa/Psm of peak intensity Psa in associated particles to peak intensity Psm in main particles, non-associated hollow nano-silica particles, is 0.4 or less.

This technique involves firing at 700° C. in the presence of an organic acid, such as citric acid, to improve dispersibility of the hollow nano-silica particles. In these hollow nano-silica particles, associated particles are prevented from being produced, and light is prevented from reflecting on the particles. Thus, these particles can be suitably used in various articles that require anti-reflection properties.

### CITATION LIST

### Patent Literature

PLT 1: JP2020-176037A

### SUMMARY OF INVENTION

### Technical Problem

The present invention provides a method of producing silica particles without using citric acid, and also provides silica particles having excellent true density and excellent dispersibility.

### Solution to Problem

As a result of extensive study, the present inventors developed new silica particles (preferably hollow silica particles) having low true density and excellent dispersibility by carbonizing core-shell particles before firing when producing silica particles.

The present invention encompasses silica particles and a method of producing silica particles defined below.
Item 1. Silica particles having
(1) a true density of 0.8 g/cm³ to 1.4 g/cm³,
(2) a particle size distribution in which a frequency of particles larger than twice an average particle size is 15%- or less, and
(3) a water absorption of 1.0 mass % or less.
Item 2.
The silica particles according to Item 1, wherein (4) the silica particles are carbonized and fired.
Item 3.
The silica particles according to Item 1 or 2, wherein (5) the average particle size is 0.2 μm to 1.0 μm.
Item 4.
The silica particles according to item 1 or 2, wherein the silica particles are hollow silica particles.
Item 5.
A method of producing silica particles, comprising first carbonizing and then firing core-shell particles,
wherein the silica particles have
(1) a true density of 0.8 g/cm³ to 1.4 g/cm³,
(2) a particle size distribution in which a frequency of particles larger than twice an average particle size is 15% or less, and
(3) a water absorption of 1.0 mass % or less.

The silica particles of the present invention are novel silica particles (preferably hollow silica particles) having low true density and excellent dispersibility.

### Advantageous Effects of Invention

The present invention provides a method of producing silica particles without using citric acid, and also provides silica particles having excellent true density and excellent dispersibility.

### DESCRIPTION OF EMBODIMENTS

The present invention will be described in detail below.

The embodiments representing the present invention are described for better understanding of the gist of the invention, and are not intended to limit the content of the invention unless otherwise specified.

Herein, the terms “include” and “contain,” and their variations express concepts that encompass comprising, consisting essentially of, and consisting of.

Herein, when a numerical range is expressed as “A to B,” the expression means A or more and B or less.

Herein, expressions such as “part(s)” and “%” are generally used.

Herein, these expressions indicate part(s) by mass or mass % (wt %) unless otherwise specified.

### 1. Silica Particles

The present invention encompasses silica particles.

The silica particles of the present invention have
(1) a true density of 0.8 g/cm³ to 1.4 g/cm³,
(2) a particle size distribution in which the frequency of particles larger than twice the average particle size is 15% or less, and
(3) a water absorption of 1.0 mass % or less.

Preferably, (4) the silica particles are carbonized and fired.

Preferably, (5) the average particle size of the silica particles is 0.2 μm to 1.0 μm.

Preferably, the silica particles are hollow silica particles.

The silica particles of the present invention are novel silica particles having low true density and excellent dispersibility.

The silica particles of the present invention are useful for multilayer printed circuit boards, wire covering materials, semiconductor encapsulants, and the like.

### Silica-Based Compound and Metal Oxide

Any silica-based compound may be used to form silica particles as long as the compound contains silica. The silica particles may consist of silica.

When the silica-based compound contains a compound other than silica, preferably, the silica particles contain silica and a metal oxide.

Preferably, the metal oxide is an oxide of a metal capable of forming a metal alkoxide. Specifically, the meal oxide is an oxide of aluminum, titanium, zirconium, or the like.

These metal oxides may be used alone or in combination (blend) of two or more.

Use of an oxide of aluminum as the metal oxide enables adjustment of the surface charge (zeta potential etc.) of shells of the silica particles.

Use of an oxide of titanium or zirconium as the metal oxide enables adjustment of the refractive index of the shells of the silica particles.

### (1) True Density of Silica Particles

The silica particles of the present invention have a true density of 0.8 g/cm³ to 1.4 g/cm³.

The true density of the silica particles of the present invention is lower than the true density of general silica (2.2 g/cm³) because the silica particles of the present invention each have a low-density air layer.

The true density of silica particles is the value determined by measuring the true density of silica particles (powder: 0.2 g) using a nitrogen gas pycnometer (Ultrapyc 5000 Micro available from Anton Paar Japan K.K.).

To measure the true density of silica particles, preferably, the powder of the particles is first vacuum-dried at a temperature of 120° C. for 2 hours, and then the powder of the dried silica particles is measured.

The true density of the silica particles is 0.8 g/cm³ to 1.4 g/cm³, preferably 0.8 g/cm³ to 1.3 g/cm³, more preferably 0.9 g/cm³ to 1.2 g/cm³, still more preferably 0.9 g/cm³ to 1.1 g/cm³. Since the true density is adjusted within the above range, the silica particles can be successfully produced. The resulting silica particles have low true density and excellent dispersibility, without broken shells.

### (2) Particle Size Distribution of Silica Particles

The silica particles of the present invention have a particle size distribution in which the frequency of particles larger than twice the average particle size is 15% or less.

The “particles larger than twice the average particle size” do not include particles twice the average particle size. The phrase refers to particles larger than twice the average particle size.

The frequency of particles larger than twice the average particle size of the silica particles in the particle size distribution is the value determined by measuring the particle size distribution of the powder of the silica particles using a laser diffraction/scattering particle size distribution analyzer (LA-950 available from Horiba, Ltd.) and calculating the frequency (%) of particles larger than twice the average particle size in the powder of the silica particles.

It is better when the frequency of particles larger than twice the average particle size of the silica particles in the particle size distribution is lower. The frequency of particles larger than twice the average particle size of the silica particles in the particle size distribution is 15% or less, preferably 12% or less, more preferably 9% or less, still more preferably 6% or less. The lower frequency limit of particles larger than twice the average particle size of the silica particles in the particle size distribution is about 0%. Since the frequency of particles having a particle size of 1 μm or more in the particle size distribution is adjusted within the above range, the silica particles can be successfully produced. The resulting silica particles have low true density and excellent dispersibility.

### (3) Water Absorption of Silica Particles

The silica particles of the present invention have a water absorption of 1.0 mass % or less.

### Water Absorption Test of Silica Particles

The water absorption of the silica particles is the value determined by storing silica particles (powder: 1 g) at a temperature of 50° C. and a humidity of 75% for 7 days, sampling 0.1 g of the powder, and then measuring the moisture content of the silica particles using a Karl Fischer moisture meter (MKA-610 available from Kyoto Electronics Manufacturing Co., Ltd.).

It is better when the water absorption of the silica particles is lower. The water absorption of the silica particles is 1.0 mass % or less, preferably 0.9 mass % or less, more preferably 0.8 mass % or less, still more preferably 0.7 mass % or less. The lower water absorption limit of the silica particles is about 0.1 mass %. Since the water absorption is adjusted within the above range, the silica particles can be successfully produced. The resulting silica particles have low true density and excellent dispersibility.

### (4) Carbonization and Firing of Silica Particles

Preferably, the silica particles of the present invention are carbonized and fired. Since the silica particles are carbonized and fired, the silica particles can be successfully produced. The resulting silica particles have low true density and excellent dispersibility.

### (5) Average Particle Size of Silica Particles

Preferably, the silica particles of the present invention have an average particle size of 0.2 μm to 1.0 μm.

The average particle size of the silica particles is the value determined by taking photographs of the particles at an accelerating voltage of 8 kV, measuring the short diameter of each of 100 randomly selected particles, and calculating the average, using a scanning electron microscope (SEM) (JSM-7900F available from JEOL Ltd.)

Image analysis is performed using WinROOF image analysis and measurement software.

The average particle size of the silica particles is preferably 0.2 μm to 1.0 μm, more preferably 0.3 μm to 0.9 μm, still more preferably 0.4 μm to 0.8 μm, particularly preferably 0.4 μm to 0.7 μm. Since the average particle size is adjusted within the above range, the silica particles can be successfully produced. The resulting silica particles have low true density and excellent dispersibility.

### (6) Hollow Silica Particles

The silica particles of the present invention may have a dense, porous, or hollow particle structure, for example.

Preferably, the silica particles are hollow silica particles. Preferably, the hollow silica particles are silica particles in each of which a hollow portion (cavity) is formed.

Since the silica particles are hollow silica particles, the silica particles can be more successfully produced. The resulting silica particles have low true density and excellent dispersibility.

### (7) MEK Filterability of Silica Particles

Preferably, the silica particles of the present invention have a methyl ethyl ketone (IEK) filterability of 80 mass % or more.

To determine the MEK filterability of the silica particles, first, the silica particles (powder: 2 g) are mixed with methyl ethyl ketone (MEK) (8 g) under stirring at 500 rpm for 2 hours, and then the resulting mixture of the silica particles and MEK is filtered through a syringe filter having a pore diameter of 5 μm (filter paper that allows passage of a substance sized 5 μm or less).

The MEK filterability of the silica particles (mass %) is the value determined by weighing the amount of the mixture that passed through the filter and calculating using the following equation.

MEK filterability (mass=, wt %)=[Amount passed (g)]÷[Amount of MEK dispersion of silica particles (10 g)]×100

It is better when the MEK filterability of the silica particles is higher. The MEK filterability of the silica particles is preferably 80 mass % or more, more preferably 85 mass % or more, still more preferably 90 mass % or more. The upper NEK filterability limit of the silica particles is about 100%. Since the MEK filterability limit of the silica particles is adjusted within the above range, the silica particles can be successfully produced. The resulting silica particles have low true density and excellent dispersibility.

### Average Thickness of Shells (Membranes) of Silica Particles

The average thickness of shells (membranes) forming the silica particles of the present invention is preferably 25 nm to 170 nm, more preferably 30 nm to 150 nm, still more preferably 35 nm to 100 nm.

The average thickness of the shells forming the silica particles is the value determined by taking photographs of the particles at an accelerating voltage of 200 kV, measuring the shell thickness of 100 randomly selected particles, and calculating the average, using a TEM (transmission electron microscope: JEM-2010 available from JEOL Ltd.).

Since the average shell thickness is adjusted within the above range, the silica particles can be successfully produced. The resulting silica particles have low true density and excellent dispersibility, without broken shells.

The silica particles of the present invention are silica particles having low true density and excellent dispersibility. The silica particles of the present invention are silica particles that exhibit low true density and high dispersibility owing to optimization of firing conditions (pre-carbonization).

### (2) Core-Shell Particles

The present invention encompasses core-shell particles.

The core-shell particles of the present invention are core-shell particles including cores consisting of organic polymer particles, and shells consisting of silica coating the organic polymer particles. Thermal decomposition of the organic polymer particles of the core-shell particles enables successful production of the silica particles of the present invention.

### Organic Polymer Particles

The organic polymer particles are not limited. Preferably, the organic polymer particles are those that are easily burned off due to thermal decomposition after the shells are formed. Specific examples of the organic polymer particles include polystyrene particles and methyl polymethacrylate (Ph A) (resin) particles.

Use of polystyrene particles as the organic polymer particles can impart a positive zeta potential to the polystyrene particles and prevent or reduce formation of associated particles.

### Dispersant

Preferably, the organic polymer particles contain a dispersant. Since the organic polymer particles contain a dispersant, the dispersant is present on the surface of each organic polymer particle, making it possible to further prevent or reduce aggregation of the organic polymer particles.

Any dispersant may be used as long as the organic polymer particles can be produced. Specific examples of the dispersant include polyvinylpyrrolidone (PVP), hydroxypropyl cellulose (HPC), polyvinyl alcohol (PVA), polyethylene oxide (PEO), polypropylene glycol (PPG), polypropylene oxide (PPO), collagen, and polysaccharides (gum arabic).

Use of polyvinylpyrrolidone, hydroxypropyl cellulose, or the like as the dispersant makes it possible to prevent or reduce aggregation of the organic polymer particles and prevent or reduce aggregation of the core-shell particles.

These dispersants may be used alone or in combination (blend) of two or more.

The amount of the dispersant in the organic polymer particles is not limited. The amount of the dispersant in the organic polymer particles is preferably 0.01 mass % to 100 mass %, more preferably 0.05 mass % to 100 mass %, per 100 mass % of the organic polymer particles. Since the amount of the dispersant is adjusted within the above range, aggregation of the organic polymer particles can be prevented or reduced.

### Silica Coating Organic Polymer Particles

A silica-based compound that forms the shells coating the organic polymer particles is the same as the silica-based compound that forms the silica particles. The average thickness of the shells (membranes) of the core-shell particles is the same as the membrane thickness (average thickness) of the shells (membrane) forming the silica particles.

### Average Particle Size of Core-shell Particles

The average particle size of the core-shell particles is preferably 0.2 μm to 1 μm, more preferably 0.3 μm to 0.9 μm, still more preferably 0.4 μm to 0.8 μm.

As is the case for the average particle size of the silica particles, the average particle size of the core-shell particles is the value determined by taking photographs of the particles at an accelerating voltage of 8 kV, measuring the short diameter of each of 100 randomly selected particles, and calculating the average, using a scanning electron microscope (SEM: JSM-7900F available from JEOL Ltd.).

Image analysis is performed using WinROOF image analysis and measurement software.

Since such core-shell particles are used, the silica particles can be successfully produced. The resulting silica particles have low true density and excellent dispersibility.

### 3. Method of Producing Silica Particles

Preferably, the method of producing silica particles of the present invention includes:
(1) step 1 of polymerizing an organic monomer in a solution containing the organic monomer, a dispersant, and a solvent to prepare organic polymer particles;
(2) step 2 of adding the organic polymer particles obtained in step 1, an alkoxysilane or a mixture of an alkoxysilane and a metal alkoxide, and a basic catalyst to a solvent, stirring the contents to prepare a solution, and forming, in the solution, core-shell particles including cores consisting of the organic polymer particles and shells coating the organic polymer particles;
(3) step 3 of first carbonizing (thermally decomposing) and then firing the core-shell particles obtained in step 2 to remove the organic polymer particles as the cores of the core-shell particles; and then,
(4) step 4 of hydrophobizing (hydrophobic surface treating) hollow silica particles obtained in step 3.

In the method of producing silica particles of the present invention, step 3 includes
first carbonizing and then firing the core-shell particles,
whereby the method can produce silica particles having
(1) a true density of 0.8 g/cm³ to 1.4 g/cm³,
(2) a particle size distribution in which the frequency of particles larger than twice the average particle size is 15% or less, and
(3) a water absorption of 1.0 mass % or less.

In the method of producing silica particles of the present invention, the core-shell particles are carbonized before firing when producing silica particles, whereby novel silica particles having low true density and excellent dispersibility can be produced.

Preferably, the method of producing silica particles of the present invention includes
the carbonization at 400° C. to 1,200° C., and
the firing for at least 3 hours.

The silica particles of the present invention can be successfully produced preferably through the following steps.

### (1) Step 1 (Production of Organic Polymer Particles)

Step 1 is a step of polymerizing an organic monomer in a solution containing the organic monomer, a dispersant, and a solvent to prepare organic polymer particles.

### Organic Monomer

Any organic monomer may be used as long as organic polymer particles can be produced.

Preferably, the organic monomer is an organic monomer that can form organic polymer particles that are easily burned off due to thermal decomposition after the shells are formed. Specific examples of the organic monomer include styrene for producing polystyrene and methyl methacrylate for producing polymethyl methacrylate (PMMA) (resin).

Use of styrene as the organic monomer can impart a positive zeta potential to the polystyrene particles and prevent or reduce formation of associated particles.

Any polystyrene may be used. A preferred polystyrene includes a structural unit derived from a hydrophobic monomer, such as alkyl (meth)acrylate and another monomer structural unit that can be co-polymerized. Preferred examples include alkyl (meth)acrylate styrene and 2-methylstyrene each having a C3-C22 alkyl group.

In step 1, the concentration of the organic monomer in the solution is not limited. The concentration of the organic monomer in the solution is preferably 0.1 mass % to 20 mass %, more preferably 0.2 mass % to 10 mass %, per 100 mass % of the solution. Since the concentration of the organic monomer is adjusted within the above range, the average particle size of the silica particles as the final product can be successfully controlled.

### Dispersant

Any dispersant may be used as long as the organic polymer particles can be produced. Specific examples of the dispersant include polyvinylpyrrolidone (PVP), hydroxypropyl cellulose (HPC), polyvinyl alcohol (PVA), polyethylene oxide (PEO), polypropylene glycol (PPG), polypropylene oxide (PPO), collagen, and polysaccharides (gum arabic).

Use of polyvinylpyrrolidone or hydroxypropyl cellulose as the dispersant makes it possible to prevent or reduce aggregation of polystyrene particles and prevent or reduce aggregation of core-shell particles to be formed in the subsequent step 2.

These dispersants may be used alone or in combination (blend) of two or more.

In step 1, the concentration of the dispersant in the solution is not limited. The concentration of the dispersant in the solution is preferably 0.01 mass % to 10 mass %, more preferably 0.05 mass % to 5 mass %, per 100 mass % of the solution. Since the concentration of the dispersant is adjusted within the above range, aggregation of the organic polymer particles can be prevented or reduced, and aggregation of core-shell particles to be formed in the subsequent step 2 can be prevented or reduced.

### Solvent

Preferably, the solvent for use in step 1 is water.

Preferably, the solvent is a hydrophilic solvent.

Preferably, the hydrophilic solvent is an alcohol, such as methanol, ethanol, n-propanol, isopropanol, ethylene glycol, propylene glycol, or 1,4-butanediol. Preferably, the hydrophilic solvent is a ketone, such as acetone or methyl ethyl ketone. Preferably, the hydrophilic solvent is an ester, such as ethyl acetate.

The hydrophilic solvent is preferably an alcohol, more preferably methanol, ethanol, isopropanol, or the like.

These solvents may be used alone or in combination (blend) of two or more.

Preferably, the solvent for use in step 1 is a solvent mixture of water and methanol. Use of a solvent mixture of water and methanol makes it possible to prevent or reduce aggregation of the organic polymer particles and prevent or reduce aggregation of core-shell particles to be formed in the subsequent step 2.

The mass ratio of water to methanol (water:methanol) in the solvent mixture is preferably 5:95 to 50:50, more preferably 8:92 to 40:60, still more preferably 10:90 to 30:70. Since the mass ratio of water to methanol is adjusted within the above range, aggregation of the organic polymer particles can be prevented or reduced and aggregation of core-shell particles to be formed in the subsequent step 2 can be prevented or reduced.

### Cationic Polymerization Initiator

In step 1, preferably, the solution contains a cationic polymerization initiator. Any cationic polymerization initiator may be used as long as organic polymer particles can be obtained. The cationic polymerization initiator is preferably an inorganic peroxide, an organic initiator, a redox agent, or the like, more preferably a radical polymerization initiator, such as an organic oxide or an azo compound.

The organic oxide is represented by formula RO—OR.

The azo compound is represented by formula A-CN═CN-A.

Specific examples of the cationic polymerization initiator include benzoyl peroxide, 2,2′-azobis(isobutylamidine) dihydrochloride (AIBA), 4,4′-azobis-4-cyanovaleric acid, azobisisobutyronitrile (AIBN), and 2,2′-azobis(2-methylpropioamide)dihydrochloride (AAPH).

The cationic polymerization initiator is preferably 2,2′-azobis(isobutylamidine) dihydrochloride (AIBA) or 2,2′-azobis(2-methylpropioamide)dihydrochloride (AAPH), more preferably 2,2′-azobis(isobutylamidine) dihydrochloride (AIBA), 4,4′-azobis-4-cyanovaleric acid, or the like, still more preferably 2,2′-azobis(isobutylamidine) dihydrochloride (AIBA).

These cationic polymerization initiators may be used alone or in combination (blend) of two or more.

In step 1, the concentration of the cationic polymerization initiator in the solution is not limited. The concentration of the cationic polymerization initiator is preferably 0.01 mass % to 1 mass %, based on the concentration of the solution taken as 100 mass %. Since the concentration of the cationic polymerization initiator is adjusted within the above range, the average particle size of the silica particles as the final product can be successfully controlled.

### Polymerization

In step 1, an organic monomer is polymerized in a solution containing the organic monomer, a dispersant, and a solvent. Preferably, the polymerization is carried out by mixing and stirring the solution.

The temperature for polymerization of the solution in step 1 is not limited. The reaction temperature for polymerization is preferably 40° C. or higher but not higher than the boiling point of the solvent used, more preferably 50° C. to 90° C. Since the reaction temperature for polymerization is adjusted within the above range, the polymerization can smoothly proceed, without the solvent being evaporated.

The reaction time for polymerization is not limited. The reaction time for polymerization is preferably 1 minute to 12 hours, more preferably 10 minutes to 10 hours. Since the reaction time for polymerization is adjusted within the above range, the polymerization can smoothly proceed.

Organic polymer particles are prepared through polymerization. The average particle size of the organic polymer particles is preferably 0.1 μm to 0.9 μm, more preferably 0.2 μm to 0.8 μm, still more preferably 0.3 μm to 0.7 μm. Since the average particle size of the organic polymer particles is adjusted within the above range, the average particle size of core-shell particles to be formed in subsequent step 2 and the average particle size of hollow silica particles to be produced in subsequent step 3 can be adjusted to fall within appropriate ranges.

Step 1 enables successful production of the organic polymer particles.

### Yield of Organic Polymer Particles (Polystyrene Particles Etc.)

2 g of the reaction solution of the organic polymer particles is weighed out into a Petri dish and dried on a hot plate at a temperature of 120° C. for 1 hour. Then, the yield of the organic polymer particles is calculated according to the following formula.

(Yield (%) of organic polymer particles)={[(Weight (g) of sample after drying)−(Weight (g) of dispersant (PVP etc.) fed into sample before drying (g))]÷[Weight (g) of organic monomer (styrene etc.) fed into sample before drying (g)]}×100

### (2) Step 2 (Production of Core-Shell Particles)

Step 2 is a step of adding the organic polymer particles obtained in step 1, an alkoxysilane or a mixture of an alkoxysilane and a metal alkoxide, and a basic catalyst to a solvent, stirring the contents to prepare a solution, and forming, in the solution, core-shell particles including cores consisting of the organic polymer particles and shells coating the organic polymer particles.

### Solvent

Preferably, the solvent for use in step 2 is water. With use of water, core-shell particles can be safely produced at a low cost.

Preferably, the solvent is a hydrophilic solvent.

Preferably, the hydrophilic solvent is an alcohol, such as methanol, ethanol, n-propanol, isopropanol, ethylene glycol, propylene glycol, or 1,4-butanediol. Preferably, the hydrophilic solvent is a ketone, such as acetone or methyl ethyl ketone. Preferably, the hydrophilic solvent is an ester, such as ethyl acetate.

The hydrophilic solvent is preferably an alcohol, more preferably methanol, ethanol, isopropanol, or the like.

Preferably, the solvent is the same type of alcohol as the alcohol produced by hydrolysis of a silicon compound. Use of the same type of alcohol as the alcohol produced by hydrolysis of a silicon compound facilitates recovery and reuse of the solvent.

These solvents may be used alone or in combination (blend) of two or more.

Preferably, the solvent is a solvent mixture of water and a hydrophilic solvent. The mass ratio of the hydrophilic solvent (methanol etc.) to water in the solvent mixture is not limited. The ratio of the hydrophilic solvent:water (mass ratio) in the solvent mixture is preferably 50:50 to 90:10, more preferably 60:40 to 80:20. Since the mass ratio of the hydrophilic solvent to water in the solvent mixture is adjusted within the above range, the average particle size of the silica particles can be adjusted to fall within an appropriate range.

Preferably, the solvent is a hydrophobic solvent. Preferably, the hydrophobic solvent is an organic hydrocarbon solvent having a water solubility of less than about 1 g per 100 g at 100° C. Preferably, the hydrophobic solvent is a C6-C10 linear, branched, or cyclic alkane. Specific examples of the hydrophobic solvent include hexane, cyclohexane, heptane, octane, and isooctane. More preferably, the hydrophobic solvent is octane.

### Organic Polymer Particles

The organic polymer particles for use in step 2 are the organic polymer particles prepared in step 1.

The concentration of the organic polymer particles in the solution is preferably 0.01 mass % to 50 mass %, more preferably 0.01 mass % to 20 mass %.

### Alkoxysilane

Any alkoxysilane may be used in step 2.

Preferably, the alkoxysilane is a tetraalkoxysilane represented by formula (1):

Si(OR¹)₄ (1), or
a derivative thereof.

In formula (1), each R¹ is the same or different, and represents an alkyl group, preferably a C1-C8 lower alkyl group, more preferably a C1-C4 lower alkyl group, still more preferably a C1-C3 lower alkyl group.

In formula (1), specifically, R is a methyl group, an ethyl group, a propyl group, an isobutyl group, a butyl group, a pentyl group, or a hexyl group.

Use of tetramethoxysilane (TMOS) represented by formula (1) in which R¹ is a methyl group or use of tetraethoxysilane (TEOS) represented by formula (1) in which R² is an ethyl group enables successful production of silica, resulting in dense shells. More preferably, the alkoxysilane for use in step 2 is tetramethoxysilane (TMOS). The dense shells are those in which siloxane bonds are formed in a greater quantity (generally formed) and there are less residual silanol groups.

Preferably, the alkoxysilane is a trialkoxysilane represented by formula (2)

Si(OR¹)₃R² (2), or
a derivative thereof.

In formula (2), R¹ is the same as R¹ in formula (1). In formula (2), R² is a hydrogen or the same alkyl group as the alkyl group of R¹ (R¹ in formula (1)).

Preferably, the derivative of the alkoxysilane is a low condensate obtained by partially hydrolyzing the alkoxysilane.

These alkoxysilanes may be used alone or in combination (blend) of two or more.

Use of a trialkoxysilane or a tetraalkoxysilane as the alkoxysilane can prevent aggregation of the core-shell particles and facilitate surface modification with a silane coupling agent or the like.

The concentration of the alkoxysilane in the solution is preferably 0.1 mass % to 70 mass %, more preferably 1 mass % to 60 mass %, still more preferably 5 mass % to 50 mass %, particularly preferably 10 mass % to 40 mass %.

### Metal Alkoxide

In step 2, a mixture of an alkoxysilane and a metal alkoxide may be used.

Any metal alkoxide may be used. Preferred examples of the metal alkoxide include aluminum alkoxide, titanium alkoxide, and zirconium alkoxide.

Use of aluminum alkoxide enables adjustment of the surface charge (zeta potential etc.) of the shells.

Use of titanium alkoxide or zirconium alkoxide can adjust the refractive index of the shells.

These metal alkoxides may be used alone or in combination (blend) of two or more.

The concentration of the metal alkoxide in the solution is preferably 0.01 mass % to 50 mass %, more preferably 0.01 mass % to 20 mass %.

In step 2, the solution may be prepared by separately adding an alkoxysilane and a metal alkoxide.

In step 2, an alkoxysilane and a metal alkoxide may be first mixed and hydrolyzed and then added to the solution. When an alkoxysilane and a metal alkoxide are first mixed and hydrolyzed and then added to the solution, shells having a bond represented by the following formula (1) can be formed:

Si—O-M (1),
in which a metal represented by M in formula (1) is uniformly present in the shells.

In formula (1), M represents a metal derived from a metal alkoxide and is preferably aluminum, titanium, or zirconium.

For example, a method disclosed in JP2005-41722A is used as the above method of first mixing and hydrolyzing an alkoxysilane and a metal alkoxide and then adding the resulting hydrolysate to the solution maybe.

### Basic Catalyst

Any basic catalyst may be used in step 2.

When the basic catalyst is an organic base catalyst free of metal components or an inorganic catalyst free of metal components, contamination with metal impurities during the production process can be avoided.

Preferably, the organic base catalyst is a nitrogen-containing organic base catalyst, such as ethylenediamine, diethylenetriamine, triethlenetetramine, urea, ethanol amine, tetramethylammonium hydroxide (TMAH), tetramethylguanidine, or a basic amino acid.

In step 2, use of an organic base catalyst with low volatility allows the reaction to proceed smoothly because the catalyst will not volatilize in the temperature range in step 2. When a volatile base is used, the pH of the solution can be maintained by continuously adding the base.

Preferably, the inorganic base catalyst is an ammonia solution. Use of an ammonia solution is economically advantageous because of its low cost, and allows the reaction to proceed smoothly.

These basic catalysts may be used alone or in combination (blend) of two or more.

The concentration of the basic catalyst in the solution is preferably 0.1 mass % to 5 mass %, more preferably 0.5 mass % to 3 mass %.

Step 2 involves adding the organic polymer particles (polystyrene particles etc.) prepared in step 1, an alkoxysilane or a mixture of an alkoxysilane and a metal alkoxide, and a basic catalyst to a solvent and stirring the contents to prepare a solution, whereby core-shell particles including cores consisting of the organic polymer particles and shells coating the organic polymer particles can be formed in the solution.

### Production of Core-Shell Particles

The temperature of the solution in step 2 is not limited. The temperature of the solution in step 2 is preferably 5° C. to 200° C., more preferably 5° C. to 150° C. Since the temperature of the solution in step 2 is adjusted within the above range, the reaction can smoothly proceed, without the solvent being evaporated.

The stirring time in step 2 is not limited. The stirring time in step 2 is preferably 1 minute to 1,200 minutes, more preferably 1 minute to 600 minutes. Since the stirring time in step 2 is adjusted within the above range, the polymerization can smoothly proceed.

Step 2 can successfully form core-shell particles including cores consisting of the organic polymer particles (polystyrene particle etc.) prepared in step 1 and shells coating the polystyrene particles.

### (3) Step 3 (Production of Silica Particles)

The method of producing silica particles of the present invention includes a step of first carbonizing (thermally decomposing) the core-shell particles (the core-shell particles obtained in step 2) and then firing them (step 3), whereby the organic polymer particles as the cores of the core-shell particles are removed.

Preferably, the carbonization is carried out in the temperature range of 400° C. to 1,200° C.

Preferably, the firing is carried out for at least 3 hours.

Step 3 is a step of carbonizing (thermally decomposing) the core-shell particles obtained in step 2 to remove the organic polymer particles as the cores of the core-shell particles. The inside of each core-shell particle is filled with the organic polymer particles serving as the core. Carbonizing (thermally decomposing) the organic polymer particles can remove the organic polymer particles as the cores of the core-shell particles, resulting in silica particles including hollow shells, which can be used effectively as a highly functional material.

In the method of producing silica particles of the present invention, the core-shell particles are carbonized before firing when producing silica particles, whereby novel silica particles having low true density and excellent dispersibility can be produced.

In step 3, the organic polymer particles are removed by thermal decomposition. The thermal decomposition is carried out by first carbonization and then firing. The temperature during the carbonization and firing process is adjusted to remove the organic polymer particles and other organic components that may be residual in the silica particles, without breaking the shells of the silica particles (hollow silica particles).

### Carbonization

Step 3 involves first carbonization and then firing the core-shell particles.

Heating the core-shell particles in air decomposes the organic polymer in the core of each silica particle, and the organic polymer is gasified (converted into a decomposed gas). Such a decomposed gas, when generated as described above, may ignite in an electric furnace; or when a decomposition gas passes through the shells of the silica particles and is ejected, through-holes may be formed in the shells, reducing the true density of the hollow silica.

From this point of view, preferably, the carbonization is carried out by heating in low-oxygen conditions.

Preferably, the carbonization is carried out by heating in low-oxygen conditions. For example, a heating furnace is filled with an inert gas (Ar gas, CO₂, etc.), N₂ gas, or water vapor (H₂O) to prevent generation of decomposition gas. A carbonizer that can be used appropriately under an atmosphere of an inert gas, N₂ gas, or water vapor (H₂O) may be used for the carbonization.

When the carbonization is carried out under an atmosphere of an inert gas or N₂ gas, it is preferred to use, for example, a batch furnace (a gas atmosphere device in which an inert gas, such as N₂, CO₂, or Ar, is introduced into the furnace for heating in a low oxygen concentration; heating temperature: about 550° C.; e.g., a hot-air-circulation-type inert gas atmosphere device, medium-temperature heating equipment RBA, available from Thermal Co., Ltd.).

When the carbonization is carried out under an atmosphere of an inert gas or N₂ gas, it is preferred to use, for example, a continuous furnace (a gas heating device that continuously carries out carbonization in a single tube; heating temperature: about 450° C. to 800° C.; e.g., a gas-heated rotary kiln available from Takasago Industrial Co., Ltd.).

When the carbonization is carried out under a superheated steam atmosphere, it is preferred to use, for example, a batch furnace (e.g., a batch-type carbonizer, CYT series, CYT-200, available from CYC Co., Ltd.).

The carbonization (thermal decomposition) is carried out using a carbonizer, preferably a batch-type carbonizer.

Use of a batch-type carbonizer enables successful carbonization because of the following reasons: 1. the thermal effect is excellent due to direct heating; 2. the temperature inside the carbonization chamber (a thermal decomposition chamber or a carbonization box) can be made uniform due to the convection effect; 3. the contact area with a material to be carbonized can be enlarged due to the convection effect; and 4. the carbonizer has a (two-tier) sealing structure, and the thermal decomposition chamber is heated while blocking oxygen (under oxygen-free conditions).

Since a carbonizer is used to carbonize the core-shell particles (dry powder), the carbonization can be efficiently carried out. In the carbonizer, the carbonization chamber is heated, and superheated steam is used to evaporate the moisture from the organic polymer particles to be carbonized when the temperature reaches around 400° C.

In the carbonization, the core-shell particles (dry powder) are placed in a carbonization chamber (carbonization box), and while superheated steam is supplied into the carbonization chamber (carbonization box), the core-shell particles are heated by combustion gas from the outside of the carbonization chamber (carbonization box). The carbonization involves carbonizing the core-shell particles (dry powder) by supplying superheated steam into the carbonization chamber (carbonization box).

The carbonization involves carbonizing the core-shell particles (dry powder) using superheated steam preferably in the temperature range of 400° C. to 1,200° C. In the carbonization, the core-shell particles (dry powder) are carbonized using superheated steam more preferably in the temperature range of 450° C. to 800° C., still more preferably in the temperature range of 500° C. to 700° C. (low temperature region).

The carbonization time is not limited. The carbonization time may be appropriately adjusted and is preferably 1 hour to 12 hours, more preferably 2 to 10 hours, still more preferably 4 to 8 hours.

With use of superheated steam, the carbonization can proceed while the temperature difference in the carbonization chamber (carbonization box) is reduced due to the convection effect.

Preferably, the carbonization can be carried out for 4 to 8 hours using superheated steam in the temperature range of about 450° C. to 550° C., using a commercially available carbonizer. The carbonizer may be, for example, a batch-type carbonizer (CYT series, CYT-200, etc.) available from CYC Co., Ltd.

In the method of producing silica particles of the present invention, the core-shell particles are carbonized before firing when producing silica particles, whereby novel silica particles having low true density and excellent dispersibility can be produced.

### Firing

Step 3 involves first carbonization and then firing the core-shell particles.

Preferably, the firing is carried out using an electric furnace.

In the firing, the carbonized core-shell particles (dry powder) are fired in an electric furnace in the temperature range of preferably 350° C. to 1,500° C., more preferably 400° C. to 1,200° C., still more preferably 600° C. to 1,100° C. (high temperature region).

Preferably, the firing time is at least 3 hours. The firing time is more preferably 4 hours or more, still more preferably 5 hours or more, particularly preferably 6 hours or more. The upper firing time limit is about 10 hours.

The carbonization is first carried out, and the firing is then carried out to remove the organic polymer particles, whereby the organic polymer particles can be successfully removed from the core-shell particles, while breakage of the shells is prevented or reduced.

Preferably, the firing can be carried out in the temperature range of about 1,000° C. to 1,100° C. for at least 3 hours using a commercially available electric furnace.

Powder of the hollow silica particles obtained by removing the organic polymer particles from the organic core-shell particles is referred to as the “hollow silica particles.” The resulting powder of the hollow silica particles can be dispersed in a solvent using a disperser and can be sequentially hydrophobized.

Preferably, the disperser is an ultrasonic homogenizer, a bead mill, or the like.

In step 3, the organic polymer particles as the cores of the core-shell particles are thermally decomposed, whereby the organic polymer particles can be removed.

Through step 3 and subsequent steps, silica particles (hollow silica particles) can be successfully produced, the silica particles having
(1) a true density of 0.8 g/cm³ to 1.4 g/cm³
(2) a particle size distribution in which a frequency of particles larger than twice an average particle size is 15% or less, and
(3) a water absorption of 1.0 mass % or less.
   (4) Step of Coating with Shells

The method of producing silica particles of the present invention may further include, after step 3, a step of coating surfaces of the silica particles (hollow silica particles) with shells.

The surfaces of the silica particles are further coated with shells, whereby the average shell thickness of the silica particles can be adjusted.

The method of coating the surfaces of the silica particles with shells is not limited. Preferably, the method of coating the surfaces of the silica particles with shells follows the method of producing the core-shell particles in step 2, except that the organic polymer particles in step 2 are replaced by the hollow silica particles obtained in step 3, whereby the surfaces of the hollow silica particles can be further coated with shells.

### (5) Step 4 (Hydrophobization of Hollow Silica Particles)

Preferably, the method of producing silica particles of the present invention includes, after step 3 or the step of coating with shells, step 4 of hydrophobizing (hydrophobic surface treating) the hollow silica particles obtained in step 3. Owing to step 4, the surfaces of the hollow silica particles can be successfully hydrophobized.

The hydrophobization method is not limited. The hydrophobization method is preferably a method that includes, after step 3 or the step of coating with the shells, adding a trialkoxysilane or an organosilazane in the solvent to the hollow silica particles obtained in step 3 or the step of coating with shells and then heating the resulting mixture.

The trialkoxysilane and the organosilazane may be used in combination.

### Solvent

The solvent for use in step 4 is preferably water.

Preferably, the solvent is a hydrophilic solvent.

Preferably, the hydrophilic solvent is an alcohol, such as methanol, ethanol, n-propanol, isopropanol (IPA), ethylene glycol, propylene glycol, or 1,4-butanediol. Preferably, the hydrophilic solvent is a ketone, such as acetone or methyl ethyl ketone. Preferably, the hydrophilic solvent is an ester, such as ethyl acetate.

The hydrophilic solvent is preferably an alcohol, more preferably methanol, ethanol, isopropanol, or the like.

Use of an alcohol, such as isopropanol, as the solvent enables successful hydrophobization of the hollow silica particles.

These solvents may be used alone or in combination (blend) of two or more.

Preferably, the solvent is a solvent mixture of water and a hydrophilic solvent. The mass ratio of the hydrophilic solvent (methanol etc.) to water in the solvent mixture is not limited. The ratio of hydrophilic solvent:water (mass ratio) in the solvent mixture is preferably 90:10 to 10:90, more preferably 30:70 to 10:90. Since the mass ratio of the hydrophilic solvent to water in the solvent mixture is adjusted within the above range, the hollow silica particles can be successfully hydrophobized.

### Trialkoxysilane

Any trialkoxysilane may be used. Preferred examples of the trialkoxysilane include 3-acryloxypropyltrimethoxysilane, 3-methacryloxypropyltrimethoxysilane, 3-glycidoxypropyltrimethoxysilane, 2-(3,4-epoxycyclohexyl)ethyltrimethoxysilane, vinyltrimethoxysilane, phenyltrimethoxysilane, N-phenyl-3-aminopropyltrimethoxysilane, and trifluoropropyltrimethoxysilane. More preferred examples of the trialkoxysilane include 3-methacryloxypropyltrimethoxysilane, N-phenyl-3-aminopropyltrimethoxysilane, and trifluoropropyltrimethoxysilane.

These trialkoxysilanes may be used alone or in combination (blend) of two or more.

The concentration of the trialkoxysilane in the solution is preferably 0.01 mass % to 30 mass %, more preferably 0.05 mass % to 25 mass %.

The trialkoxysilane may be used in any amount. The amount of the trialkoxysilane used is preferably 0.01 mass % to 10 mass %, more preferably 0.05 mass % to 5 mass %, still more preferably 0.1 mass % to 3 mass %, per 100 mass % of silica. Since the amount of the trialkoxysilane used is adjusted within the above range, the hollow silica particles can be successfully hydrophobized.

The hydrophobization using the trialkoxysilane is carried out by heating preferably at 30° C. or higher, more preferably 40° C. or higher, still more preferably 50° C. or higher. The upper heating temperature limit is preferably 90° C. or lower, more preferably 80° C. or lower. Since the heating temperature for the hydrophobization using the trialkoxysilane is adjusted within the above range, the reaction between the silica particles and the trialkoxysilane can proceed without causing aggregation in the solvent.

The heating time for the hydrophobization using the trialkoxysilane is not limited. The heating time for the hydrophobization using the trialkoxysilane is preferably 10 minutes to 48 hours, more preferably 30 minutes to 24 hours, still more preferably 1 hour to 20 hours.

### Organosilazane

Any organosilazane may be used. Preferred examples of the organosilazane include tetramethyldisilazane, hexamethyldisilazane, and pentamethyldisilazane.

These organosilazanes may be used alone or in combination (blend) of two or more.

The organosilazane may be used in any amount. The amount of the organosilazane used is preferably 10 mass % to 100 mass %, more preferably 20 mass % to 90 mass %, still more preferably 40 mass % to 80 mass %, per 100 mass % of silica. Since the amount of the organosilazane used is adjusted within the above range, the hollow silica particles can be successfully hydrophobized.

The hydrophobization using the organosilazane is carried out by heating preferably at 30° C. or higher, more preferably 40° C. or higher, still more preferably 50° C. or higher. The upper heating temperature limit is preferably 90° C. or lower, more preferably 80° C. or lower. Since the heating temperature for the hydrophobization using the organosilazane is adjusted within the above range, the reaction between the silica particles and the organosilazane can proceed without causing aggregation in the solvent.

The heating time for the hydrophobization using the organosilazane is not limited. The heating time for the hydrophobization using the organosilazane is preferably 10 minutes to 48 hours, more preferably 30 minutes to 24 hours, still more preferably 1 hour to 20 hours.

The trialkoxysilane and the organosilazane may be used in combination.

The solvent in the solution containing the hydrophobized hollow silica particles may be replaced with another solvent (such as water). The solution containing the hydrophobized hollow silica particles may be filtered or dried (e.g., vacuum-dried) to remove the solvent and thus prepare a solution powder containing the hydrophobized hollow silica particles.

### (4) Method of Producing Core-Shell Particles

Preferably, the method of producing core-shell particles of the present invention includes:
(1) step 1 of polymerizing an organic monomer in a solution containing the organic monomer, a dispersant, and a solvent mixture to prepare organic polymer particles; and
(2) step 2 of adding the organic polymer particles obtained in step 1, an alkoxysilane or a mixture of an alkoxysilane and a metal alkoxide, and a basic catalyst to a solvent, stirring the contents to prepare a solution, and thus forming, in the solution, core-shell particles including cores consisting of the organic polymer particles and shells coating the organic polymer particles.

Step 1 and step 2 are the same as step 1 and step 2 described above for the method of producing silica particles.

The core-shell particles produced by the method of producing core-shell particles of the present invention from which the organic polymer particles as the cores of the core-shell particles are removed by carbonization (thermal decomposition) are suitable as the core-shell particles for use in step 3 of the method of producing silica particles of the present invention.

### EXAMPLES

The present invention is specifically described below with reference to Examples.

These Examples are not intended to limit the present invention.

According to the formulation and production conditions in Table 1, polystyrene particles and core-shell particles were prepared, and hollow silica particles were produced. A specific description is given below.

### (1) Examples and Comparative Examples Example 1

### Step 1: Production of Polystyrene Particles

First, 737 g of ultrapure water, 2949 g of methanol, and 369 g of styrene monomer (organic monomer) were poured into a four-neck flask, and the flask was heated to an internal temperature of 55° C. to 70° C. while stirring at 250 rpm under a nitrogen atmosphere.

Then, a 5 wt % aqueous solution of AIBA (2,2′-azobis(isobutylamidine)dihydrochloride) (AIBA: 7 g; ultrapure water: 140 g) dissolved in advance in ultrapure water was added as a polymerization initiator, and polymerization was carried out at 55° C. to 75° C. for 3 hours.

Subsequently, a 5% methanol solution of polyvinylpyrrolidone (PVP) (PVP: 37 g; methanol: 560 g; water: 140 g) was added as a dispersant, and the mixture was heated at a higher temperature under reflux for 3 hours. Thus, a polystyrene particle reaction solution was produced.

Commercially available PVP includes PVP K-90 available from Ashland and PITZCOL K-60L available from Daiichi Kogyo Co., Ltd. In the Examples, PVP K-90 available from Ashland was used as PVP.

The polystyrene particle reaction solution was poured into another four-neck flask and heated with a mantle heater for methanol substitution, and the reaction was ended when the internal temperature reached 70° C.

Polystyrene particles, which are organic polymer particles, were prepared in methanol.

### Yield of Polystyrene Particles

2 g of the polystyrene particle reaction solution was weighed out into a Petri dish and dried at a temperature of 120° C. on a hot plate for 1 hour. The yield of the polystyrene particles was calculated according to the following equation.

(Yield (%) of polystyrene particles)={[Weight (g) of sample after drying)−(Weight (g) of dispersant PVP fed into sample before drying)]÷[Weight (g) of styrene fed into sample before drying}×100

### Step 2: Production of Core-Shell Particles

First, a reaction apparatus equipped with a four-neck flask, a stirring blade, and a water bath was provided.

Then, 376 g of tetramethoxysilane (TMOS) (alkoxysilane) was mixed with 744 g of methanol to prepare liquid A.

Separately, 1,427 g of a dispersion of the polystyrene particles (polystyrene concentration: 7.6 wt %) produced in step 1 was added to a flask, and 829 g of water and 823 g of methanol as solvents and 268 g of a 28% aqueous ammonia solution (basic catalyst) were added to the dispersion, whereby liquid B was prepared.

Liquid A was added to liquid B over 190 minutes under stirring at 250 rpm while maintaining the temperature of liquid B at 30° C.

In the resulting solution, core-shell particles including cores consisting of polystyrene particles and silica-based shells coating the polystyrene particles were formed, whereby a dispersion of the core-shell particles was prepared. Then, water was added dropwise, and while keeping the volume at least at the same level, the aqueous ammonia solution in the concentrate was replaced with water, whereby an aqueous dispersion of the core-shell particles was prepared.

### Step 3: Production of Hollow Silica Particles (Carbonization)

The aqueous dispersion of the core-shell particles obtained in step 2 was dried on a hot plate at a temperature of 130° C., whereby powder of the core-shell particles was obtained.

First, the resulting powder of the core-shell particles was carbonized in a batch-type carbonizer (CYT-200 available from CYC Co, Ltd.) using superheated steam at a temperature of 500° C. for 4 hours.

Then, the powder was fired (heated) in an electric furnace at a temperature of 1,050° C. for 3 hours to remove the polystyrene particles, whereby powder of hollow silica particles was produced.

The resulting powder of the hollow silica particles was added to pure water (silica concentration: 20 wt %) and dispersed for 135 minutes using an ultrasonic homogenizer (UP-400S available from Hielscher Inc.).

The resulting dispersion was centrifuged at 3,200 rpm for 10 minutes using a high-speed micro-centrifuge (himac CF-16N available from Hitachi Koki Co., Ltd.) to collect the supernatant, which was then filtered through 7 μm quantitative filter paper. Thus, a dispersion of hollow silica particles (silica concentration: 16 wt %) was obtained.

The silica concentration was calculated from the amount remaining after drying the dispersion of the hollow silica particles and baking the dried dispersion at 800° C.

### Step 4: Production of Surface-Treated Hollow Silica Particles

First, a reaction apparatus equipped with a four-neck flask, a stirring blade, and a water bath was provided. To a flask were added 400 g of the aqueous dispersion of the hollow silica particles obtained in step 3, 274 g of ultrapure water, 404 g of isopropanol (IPA), and 1.4 g of N-phenyl-3-aminopropyltrimethoxysilane (KBM-573 available from Shin-Etsu Chemical Co., Ltd.) (trialkoxysilane), followed by mixing, stirring, and heating at 75° C. for 1 hour.

Then, 39 g of hexamethyldisilazane (SZ-31 available from Shin-Etsu Chemical Co., Ltd.) (organosilazane) was added dropwise, followed by heating for 2 additional hours.

Then, the reaction solution was cooled to 50° C., and 559 g of ultrapure water and 31 g of 3 M sulfuric acid were sequentially added. Then, solids were collected by vacuum filtration.

The collected solids were washed with ultrapure water, and vacuum-dried at 120° C., whereby hollow silica particles were prepared.

### Example 2

In step 4 of Example 1, only 394 g of hexamethyldisilazane was added dropwise without mixing N-phenyl-3-aminopropyltrimethoxysilane.

The same procedure was carried out under the same conditions as in Example 1, except for the process described above.

### Example 3

In step 4 of Example 1, 400 g of the aqueous dispersion of the hollow silica particles, 274 g of ultrapure water, 404 g of IPA, and 1.1 g of N-phenyl-3-aminopropyltrimethoxysilane were mixed, stirred, and heated at 75° C. for 1 hour.

The same procedure was carried out under the same conditions as in Example 1, except for the process described above.

### Comparative Example 1

In step 3 of Example 1, the powder of the core-shell particles was not carbonized, and the powder was fired (heated) in an electric furnace at a temperature of 1,050° C. for 3 hours.

The same procedure was carried out under the same conditions as in Example 1, except for the process described above.

### Comparative Example 2

In step 3 of Example 1, the powder of the core-shell particles was first carbonized in a batch-type carbonizer (CYT-200 available from CYC Co., Ltd.) using superheated steam at a temperature of 500° C. for 4 hours. Then, the powder was fired (heated) in an electric furnace at a temperature of 1,075° C. for 2 hours.

The same procedure was carried out under the same conditions as in Example 1, except for the process described above.

### Comparative Example 3

In step 3 of Example 1, the powder of the core-shell particles was first carbonized in a batch-type carbonizer (CYT-200 available from CYC Co., Ltd.) using superheated steam at a temperature of 500° C. for 4 hours. Then, the powder was fired (heated) in an electric furnace at a temperature of 1,000° C. for 1 hour.

The same procedure was carried out under the same conditions as in Example 1, except for the process described above.

### Comparative Example 4

In step 3 of Example 1, 7.7 g of citric acid (citric acid (anhydrous) available from Fuso Chemical Co., Ltd.) was added to the aqueous dispersion of the core-shell particles, and the resulting mixture was dried on a hot plate at a temperature of 130° C. Thus, powder of the core-shell particles was obtained.

The resulting powder of the core-shell particles was not carbonized, and the powder was heated in an electric furnace at a temperature of 1,050° C. for 3 hours.

The same procedure was carried out under the same conditions as in Example 1, except for the process described above.

The properties of the particles obtained in Examples and Comparative Examples were measured by the following methods.

### (2) Evaluation Test

### Particle Size

Using a scanning electron microscope (SEM) (JSM-7900F available from JEOL Ltd.), photographs of the powder of the hollow silica particles obtained in step 4 were taken at an accelerating voltage of 8 kV, and the short diameter of each of 100 randomly selected particles was measured to determine the average of the particles.

Image analysis was performed using WinROOF image analysis and measurement software.

### True Density

0.3 g of the powder of the hollow silica particles obtained in step 4 was used to measure the true density of the powder of the hollow silica particles using a nitrogen gas pycnometer (Ultrapyc 5000 Micro available from Anton Paar Japan Co., Ltd.).

### Water Absorption Test

1 g of the powder of the hollow silica particles obtained in step 4 was stored for 7 days under an environment at a temperature of 50° C. and a humidity of 75, and 0.1 g of the powder was sampled. The moisture content (mass %) of the sample was measured using a Karl Fischer moisture meter (MKA-610 available from Kyoto Electronics Manufacturing Co., Ltd.).

### MEK Filterability

2 g of the powder of the hollow silica particles obtained in step 4 was mixed with 8 g of methyl ethyl ketone (MEK) for 2 hours. The resulting mixture was filtered through a syringe filter having a pore diameter of 5 μm (filter paper that allows passage of a substance sized 5 μm or less), and the amount passed through the filter was weighed.

(MEK filterability (mass %, wt %))=[Amount passed (g))]÷[Amount of MEK dispersion of hollow silica particles (10 g)]×100

### Number of Particles Sized 1 μm or More (Particle Size Distribution)

The particle size distribution of the powder of the hollow silica particles obtained in step 4 was measured using a laser diffraction/scattering particle size distribution analyzer (LA-950 available from Horiba, Ltd.). The frequency (%) of particles having a particle size of 1 μm or more in the powder of the hollow silica particles was calculated.

Table 1 shows the results.

TABLE 1
Table 1

| | | | | | Surface treatment | | | | | | Frequency of |
|---|---|---|---|---|---|---|---|---|---|---|---|
| | | | | | Amount of | Amount of | | | | | particles larger |
| | | | | | trialkoxysi- | organo- | | Water absorption test | | | than twice average |
| | Parti- | | | | lane | silazane | | Moisture | Moisture | MEK | particle size in |
| | cle | | Firing | | added | added | True | content on | content | filter- | particle size |
| | size | Carboni- | Temp. | Time | (wt % | (wt % | density | day 0 | on day 7 | ability | distribution |
| | (μm) | zation | (° C.) | (h) | per silica) | per silica) | (g/cm³) | (wt %) | (wt %) | (wt %) | (%) |
| Example 1 | 0.5 | Performed | 1,050 | 3 | 2.2 | 61 | 1.14 | 0.03 | 0.16 | 93 | 0.0 |
| Example 2 | 0.5 | Performed | 1,050 | 3 | 0 | 61 | 1.13 | 0.09 | 0.15 | 88 | 12.6 |
| Example 3 | 0.5 | Performed | 1,050 | 3 | 1.7 | 61 | 1.06 | 0.03 | 0.15 | 94 | 5.1 |
| Comparative | 0.5 | Not | 1,050 | 3 | 2.2 | 61 | 1.23 | 0.07 | 0.13 | 12 | 66.6 |
| Example 1 | | performed | | | | | | | | | |
| Comparative | 0.5 | Performed | 1,075 | 2 | 2.2 | 61 | 1.17 | 0.06 | 0.11 | 42 | 55.2 |
| Example 2 | | | | | | | | | | | |
| Comparative | 0.5 | Performed | 1,000 | 1 | 2.2 | 61 | 1.05 | 0.15 | 3.80 | 38 | 31.1 |
| Example 3 | | | | | | | | | | | |
| Comparative | 0.5 | Not | 1,050 | 3 | 2.2 | 61 | 1.25 | 0.10 | 0.27 | 23 | 22.5 |
| Example 4 | | performed | | | | | | | | | |
| Amount of citric | | | | | | | | | | | |
| acid added | | | | | | | | | | | |
| (3 wt % per silica) | | | | | | | | | | | |

### (3) Evaluation Results

In Comparative Example 1, hollow silica particles were prepared by simply firing the powder of the core-shell particles, without carbonizing. In Comparative Example 1, the hollow silica particles had a particle size distribution in which the frequency of particles larger than twice the average particle size exceeded 15%.

In Comparative Example 2, hollow silica particles were prepared by carbonizing the powder of the core-shell particles and firing them for 2 hours. In Comparative Example 2, the hollow silica particles had a particle size distribution in which the frequency of particles larger than twice the average particle size exceeded 15%.

In Comparative Example 3, hollow silica particles were prepared by carbonizing the powder of the core-shell particles and firing them for 1 hour. In Comparative Example 3, the hollow silica particles had a particle size distribution in which the frequency of particles larger than twice the average particle size exceeded 15%, and the hollow silica particles had a water absorption exceeding 1.0 mass %.

In Comparative Example 4, hollow silica particles were prepared by adding citric acid to the aqueous dispersion of the core-shell particles and then simply firing powder of the core-shell particles without carbonization. In Comparative Example 4, the hollow silica particles had a particle size distribution in which the frequency of particles larger than twice the average particle size exceeded 15%.

The hollow silica particles of Examples 1 to 3 are the embodiments of the present invention, which were prepared by carbonizing the powder of the core-shell particles in the temperature range of 400° C. to 1,200° C. and firing for at least 3 hours. The hollow silica particles of Examples 1 to 3 were hollow silica particles having (1) a true density of 0.8 g/cm³ to 1.4 g/cm³, (2) a particle size distribution in which the frequency of particles larger than twice the average particle size is 15% or less, and (3) a water absorption of 1.0 mass % or less.

### (4) Industrial Applicability

The hollow silica particles of the present invention are novel silica particles having low true density and excellent dispersibility.

The method of producing hollow silica particles of the present invention can produce novel hollow silica particles having low true density and excellent dispersibility by carbonizing core-shell particles before firing when producing hollow silica particles.

The hollow silica particles of the present invention are useful for multilayer printed circuit boards, wire covering materials, semiconductor encapsulants, and the like.

1. Silica particles having
(1) a true density of 0.8 g/cm³ to 1.4 g/cm³,
(2) a particle size distribution in which a frequency of particles larger than twice an average particle size is 15% or less, and
(3) a water absorption of 1.0 mass % or less.

2. The silica particles according to claim 1, wherein (4) the silica particles are carbonized and fired.

3. The silica particles according to claim 1, wherein (5) the average particle size is 0.2 μm to 1.0 μm.

4. The silica particles according to claim 1, wherein the silica particles are hollow silica particles.

5. A method of producing silica particles, comprising first carbonizing and then firing core-shell particles,
wherein the silica particles have
(1) a true density of 0.8 g/cm³ to 1.4 g/cm³,
(2) a particle size distribution in which a frequency of particles larger than twice an average particle size is 15% or less, and
(3) a water absorption of 1.0 mass % or less.
